(19) United States
(12) Patent Application Publication
(10) Pub. No.: US 2017/0357799 A1
(43) Pub. Date: Dec. 14, 2017

(54) Tracking and managing multiple time-based one-time password (TOTP) accounts

(71) Applicant: LogMeIn, Inc., Boston, MA (US)

(72) Inventors: Zsolt Fehér, Budapest (HU); Gábor Mihály, Budapest (HU); Joseph Siegrist, Fairfax, VA (US)

(21) Appl. No.: 15/619,836

(22) Filed: Jun. 12, 2017

Related U.S. Application Data
(60) Provisional application No. 62/348,980, filed on Jun. 12, 2016.

(51) Int. Cl. G06F 21/45; H04L 29/06

(52) U.S. Cl. CPC G06F 21/45; H04L 63/0838; H04L 63/0846; H04L 2463/082

(57) ABSTRACT

A host machine has a web browser. A user of the host machine also has a mobile device. A time-based, one-time password (TOTP) authentication scheme leverages a plug-in associated with the browser to automatically inject a received TOTP code into an element of an HTML-based TOTP authentication page, and to programmatically submit the HTML form (e.g., by mimicking the “click to submit” button on the TOTP form). Typically, the TOTP code is obtained following a successful completion of a push notification interaction between a cloud service, which stores TOTP shared secrets that are used to generate the TOTP codes, and the user of the mobile device. As a further feature, a method to keep track of multiple TOTP accounts and to find the account usable for a given website are also provided.

### BACKGROUND

### Technical Field

This disclosure relates generally to security technologies, products and services.

### Background of the Related Art

Two-factor authentication (also known as 2FA) is a technology that provides identification of users by combining two different components, such as something that the user knows (e.g., username, password, PIN), and something that the user possesses (USB stick with a secret token, a bank card, a key) or something that is inseparable from the user (e.g. a fingerprint, iris, voice, typing speed, pattern in key press intervals, etc.). If, in an authentication attempt, at least one of the components is missing or supplied incorrectly, the user's identity is not established and access to the resource being protected by two-factor authentication is denied. The something possessed by the user may be a mobile device itself.

A number of two-factor authentication schemes use a Time-based One-time Password (TOTP) scheme, as defined Internet RFC 6238. TOTP is an algorithm that computes a one-time password from a shared secret key and the current time. TOTP is an example of a hash-based message authentication code (HMAC). It combines a secret key with the current timestamp using a cryptographic hash function to generate a one-time password. The timestamp typically increases in 30-second intervals such that passwords generated close together in time from the same secret key are the same. In a typical two-factor authentication application, a user enters his private credential (e.g., username and password) into a website, generates a one-time password (OTP) for the site using TOTP running locally on a smartphone, and types the OTP into the server as well. The server runs the same TOTP algorithm to verify the one-time password entered. The approach requires that a single secret key be shared between the server and the user's device over a secure channel ahead of time.

### BRIEF SUMMARY

This disclosure relates to a method to manage TOTP accounts, e.g., TOTP accounts that are implemented in association with a TOTP-based two factor authentication scheme.

In one aspect, a website-to-TOTP issuer data structure is established for a first set of websites, and for a second set of websites, the second set of websites being distinct from the first set of websites and being associated with a particular user. Preferably, the website-to-TOTP issuer data structure for the first set of websites represents a global mapping table for commonly-used websites. According to the method, a request for a TOTP code is received, typically during an attempt to login to a given website. In response, the website-to-TOTP issuer data structure(s) are checked for a match. Preferably, the website-to-TOTP issuer data structure for the first set of websites is checked for the match first, and the website-to-TOTP issuer data structure for the second set of websites is checked if no match is found for the first set of websites. In response to a determination that a match does not exist, a request to obtain a TOTP account is issued. Then, and in response to receipt of a response to the request to obtain the TOTP account, the website-to-TOTP issuer data structure for the second set of websites is updated.

According to another aspect, an apparatus to manage TOTP accounts in a backend infrastructure is described. The apparatus includes a data store storing (a) common URL-to-TOTP issuer mappings; and (b) per-user URL-to-TOTP issuer mappings. Program code executed by a processor is provided to dynamically update the per-user URL-to-TOTP issuer mappings to enable automated and reliable locating of a correct TOTP code for a given website.

The foregoing has outlined some of the more pertinent features of the subject disclosure. These features should be construed to be merely illustrative. Many other beneficial results can be attained by applying the disclosed subject matter in a different manner or by modifying the subject matter as will be described.

### BRIEF DESCRIPTION OF THE DRAWINGS

For a more complete understanding of the disclosed subject matter and the advantages thereof, reference is now made to the following descriptions taken in conjunction with the accompanying drawings, in which:

FIG. 1 depicts the various components in which the techniques of this disclosure may be carried out;

FIG. 2 is a UML interaction diagram depicting a setup flow by which a TOTP shared secret per user per site is generated and maintained in the cloud service;

FIG. 3 is a UML interaction diagram depicting a login flow by which an end user logs into a site protected by TOTP-authentication using the technique of this disclosure;

FIG. 4 depicts the end user web browser and the end user mobile device interaction during the push notification operation initiated by the browser plug-in;

FIG. 5 depicts the browser plug-in injecting the TOTP code into the TOTP authentication page to enable programmatic login according to this disclosure;

FIG. 6 depicts a sequence diagram for acquiring a TOTP code according to this disclosure;

FIG. 7 depicts a sequence diagram depicting an account pairing saving function according to a first option;

FIG. 8 depicts a sequence diagram depicting an account pairing saving function according to a second option; and

FIG. 9 depicts a sequence diagram depicting an account pairing saving function according to a third option.

### DETAILED DESCRIPTION OF AN ILLUSTRATIVE EMBODIMENT

By way of background, the following describes a way to enable an end user to access a set of “sites” using a conventional TOTP-based two factor authentication (2FA) scheme but without requiring the user to manually enter TOTP codes in a mobile device, or to configure and maintain separate mobile applications (apps) for each site. As used herein, the term “site” typically refers to a website (or some protected portion thereof), but the reference to a “site” should be broadly construed to refer to any protected resource available from a server or other computing entity. Typically, the end user has associated therewith both a mobile device running a mobile authenticator app, as well as a second computing machine, such as a laptop or desktop running a web browser. The mobile authenticator app need not be a dedicated mobile app for the site, or that corresponds to the site's origin. The mobile device may be a smartphone, tablet or wearable (e.g., Apple iPhone® and iPad® tablet, iWatch™, Google® Glass™, and others), an IoT device or appliance, or the like. The mobile authenticator app be downloaded and installed via a mobile application delivery service, such as the Apple® App™ Store, Google Play Store (or equivalents), or it may be provided as a native application on the mobile device.

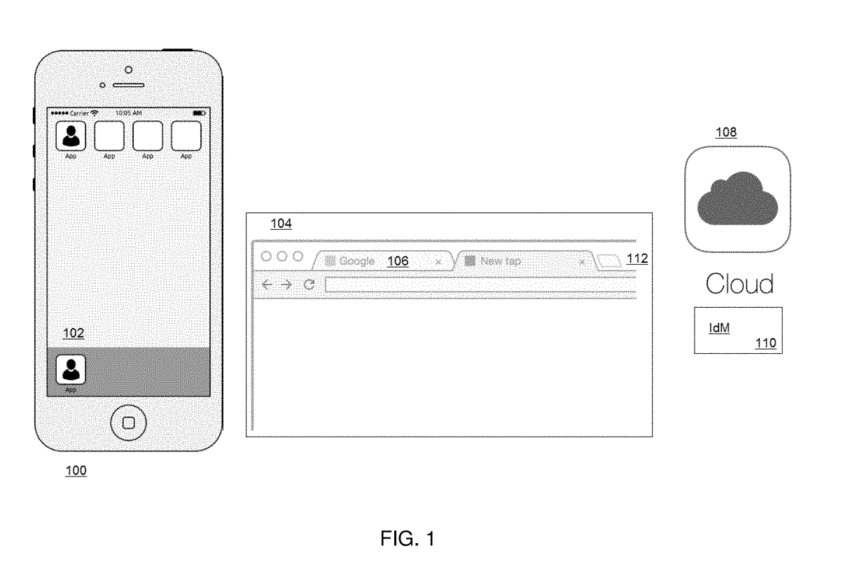

Referring now to FIG. 1, a technique of this type involves a set of computing elements: an end user mobile device 100 running a generic authenticator app 102, a computing entity 104 running a web browser 106, and a cloud service 108 having an identity manager 110. The identity manager 110 includes a data repository that stores TOTP secrets (namely, a TOTP-shared secret per user per site). Each of the mobile device 100 and 110 are enabled to provide TOTP-based 2FA. As also depicted, and according to a feature of this disclosure, web browser 106 is augmented with a browser plug-in 112 that facilitates various operations to facilitate cross-site TOTP-based 2FA. Although a browser plug-in 112 is a preferred implementation, the functions of this plug-in may also be implemented in other ways, e.g., an applet, an ActiveX control, JavaScript, native code, or the like. As will be seen, the plug-in 112 obviates manual entry by the end user of the TOTP code, thereby significantly increasing ease of authentication to sites using the described scheme.

In one non-limiting embodiment, the cloud service 108 is implemented in associated with a remote access architecture, such as LogMeIn®.

### Cross-Site, TOTP-Based Two Factor Authenticated Access

By way of additional background, a TOTP-based 2FA scheme works across sites 114a-n without requiring the end user to manually enter TOTP codes, or to have a dedicated mobile app for each particular site. In this approach, an end user leverages the cloud-based service 108 as a repository for maintaining and securing the TOTP secrets (i.e., a TOTP shared secret per user per site) that are generated as the end user interacts with various TOTP setup pages via the generic mobile device authenticator app 102. The notion of “generic” here is not intended to be limiting; it just refers to the fact that the end user need use a distinct mobile app for each site that is enabled for access using TOTP-based authentication. A TOTP code typically is based on the TOTP secret and other factors, such as current date and time.

The cloud service 108 is accessed when the end user subsequently attempts a TOTP-based login from the client browser 106 to one of the sites 114 (whose TOTP shared secret is already maintained in the repository). As noted, the client browser 106 executes in a computing machine (e.g., a laptop) 104 distinct from the end user's mobile device 100. To effect TOTP-based login, the end user opens the browser 106 to a TOTP authentication page. The login attempt from the client browser is detected by the browser plug-in 112, and this detection initiates a push notification mechanism. In particular, and in a preferred embodiment, the browser plug-in 112 issues a request to the cloud service 108, which responds by sending a push notification to the end user mobile device authenticator app 102. If the end user responds to the push notification (e.g., within a given timeout), the cloud service identity manager 110 uses the TOTP secret stored in the repository to generate the TOTP code, which code is then sent back to the browser plug-in 112. Conveniently, the browser plug-in 112 then automatically injects that code into an HTML login form of the TOTP authentication page, and then automatically submits the form. Thus, the user does not have to manually enter the TOTP code or take an affirmative (physical) action to even submit the form that has been filled-in with the TOTP code. Rather, according to this disclosure, once the user responds to the push notification, both the TOTP code entry and form submission occur in an automated manner under the control of the plug-in. The user is then logged in automatically to complete the process.

The above-described approach works for any site 114 for which the cloud service maintains the TOTP shared secret for the end user. In this manner, the cloud service 108 enables the end user to access secure resources without tedious end user physical interaction with the mobile app. In addition, the approach enables the end user to obtain these advantages using just a single authenticator app 102 (running the TOTP authentication scheme) instead of having to configure and use multiple different mobile apps across different web sites that implement this form of authentication.

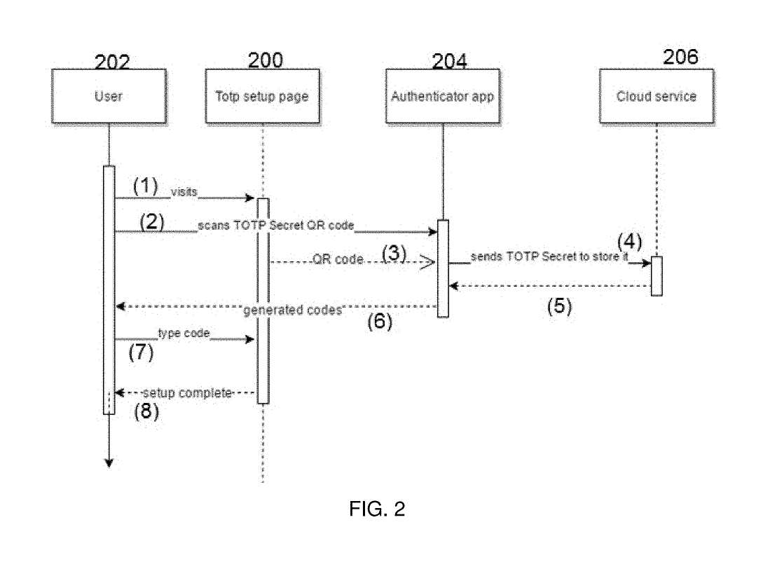

FIG. 2 depicts a process flow by which the user obtains a TOTP shared secret for a site. As depicted, the site includes a TOTP setup page 200. The setup process begins when the user 202 visits the TOTP setup page 200 at step (1). That setup page displays a QR (or equivalent) code that is then scanned by the user's authenticator app 204 running on the end user's mobile device (which the user is assumed to possess). The authenticator app 204 obtains the scanned QR code at step (3) and uses it to generate the TOTP secret for the user for the site. In an alternative, the user may manually enter information from which the TOTP secret for the user for the site is generated. At step (4), the TOTP secret (for the user for the site) is sent to the cloud service 206, which stores it in its associated identity manager. The cloud service 206 also uses the TOTP secret to generate a TOTP code, which is then returns to the authenticator app 204 at step (5). The authenticator app 204 then outputs the TOTP code to the user at step (6). At step (7), the end user types the code into the TOTP setup page 200. As described, during the actual site authentication the end user does not need to enter any code manually, as the browser plug-in is used for this purpose. At step (8), the TOTP setup page returns an indication that setup is complete. As a result, the authenticator app 204 is now enabled to access the site using TOTP-based authentication. This process is then repeated for each site; as a consequence, the cloud service data repository stores a set of TOTP secrets for the end user (one per site). There may be as many TOTP secrets stored in the repository as there are TOTP-based 2FA accessible sites, but only the single authenticator app 204 is required to enable this configuration.

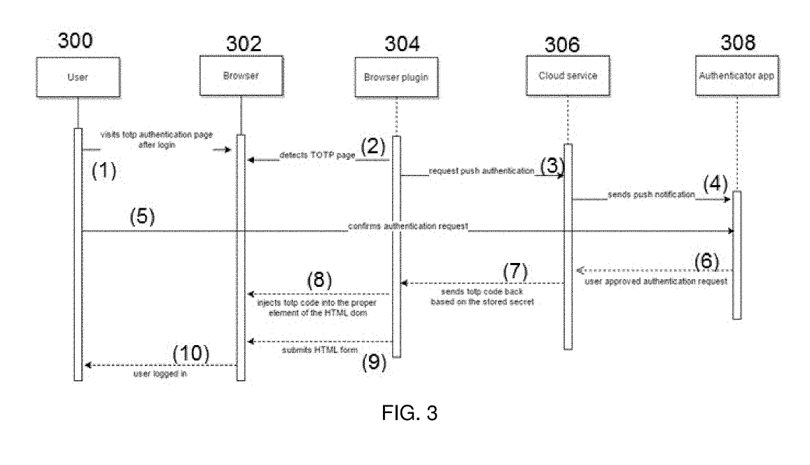

FIG. 3 depicts a process flow by which the user obtains TOTP-based authenticated access to one of the sites protected by the authentication scheme. The process assumes that the setup flow shown in FIG. 2 has been executed for a number of sites.

The routine begins at step (1) with the user 300 opening his or her browser 302 to the site's TOTP authentication page, which may require a previous login. At step (2), the browser plug-in 304 detects the TOTP authentication page being rendered in the browser 302. At step (3), the browser plug-in 304 calls an application programming interface (API) of the cloud service 306 to request push authentication. At step (4), the cloud service 306 sends a push notification to the end user's mobile device authenticator app 308, which is the same app used during the setup flow. At step (5), the user confirms the authentication request. At step (6), the authenticator app notifies the cloud service 306 that the user has approved the authentication request. The cloud service 306 then uses the stored TOTP shared secret for the user for the site to generate a TOTP code that will remain valid for a given time (e.g., 30 seconds). At step (7), the cloud service 306 sends that TOTP code back to the browser plug-in 304.

At step (8), the browser plug-in automatically injects the received TOTP code into the appropriate element of the HTML DOM (document object model) of the TOTP authentication page. Typically, this element is an HTML fill-in form. In this manner, the user does not need to type in the TOTP code manually; rather, at step (9), the browser plug-in 304 also programmatically submits the HTML form (e.g., by mimicking the “click to submit” button on the TOTP form), and by this action the user is logged in at step (10) automatically. This completes the process for the user's TOTP-authentication to this site.

Using just the single mobile device authenticator app, a similar login process may then be carried out at any other site for which the cloud service maintains the TOTP shared secret for the user.

Thus, according to this technique, the cloud service is augmented to store a TOTP shared secret per user per site. The cloud service also is enabled, e.g., through a cloud service API, to send back to the browser plug-in calculated TOTP codes. The authenticator app is augmented to provide the capability to call the cloud service API to store the TOTP shared secret per user per site in the cloud repository. The browser is augmented to include the browser plug-in (or equivalent code), which provides various functions to automate and streamline the TOTP mechanism, namely: the ability to detect if the user is visiting a TOTP authentication page, the ability to call the cloud service API to send out a push notification to the authenticator app, the ability to poll the cloud service, e.g., through a web API, to determine if the user confirmed (allowed) the authentication request, the ability to inject the TOTP code to the proper HTML element of the TOTP authentication page, and the ability to mimic the click on submit button of the TOTP form.

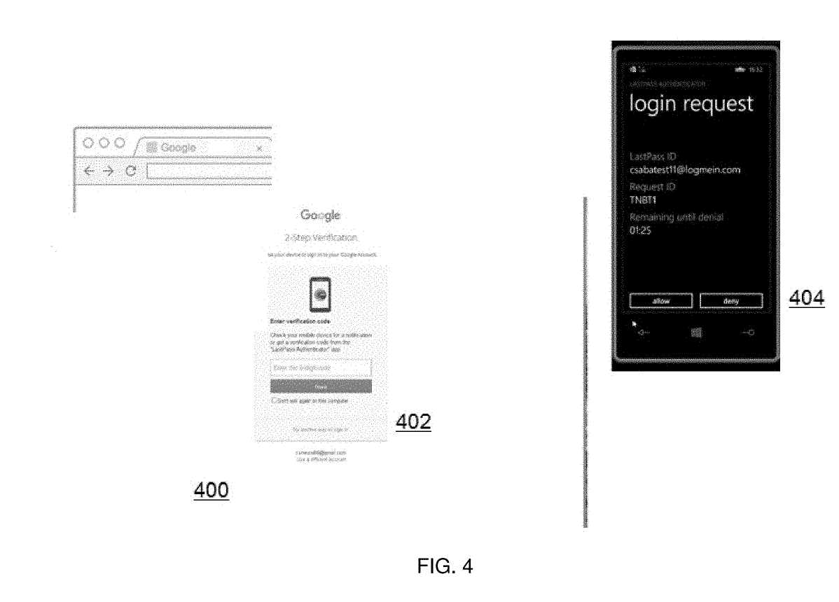

FIG. 4 depicts the browser 400 and the associated TOTP authentication page 402, and the mobile device authenticator app 404 upon receipt by the mobile device of the push notification. As depicted, preferably the push notification page includes allow and deny buttons, together with a timer that displays a timeout for the notification.

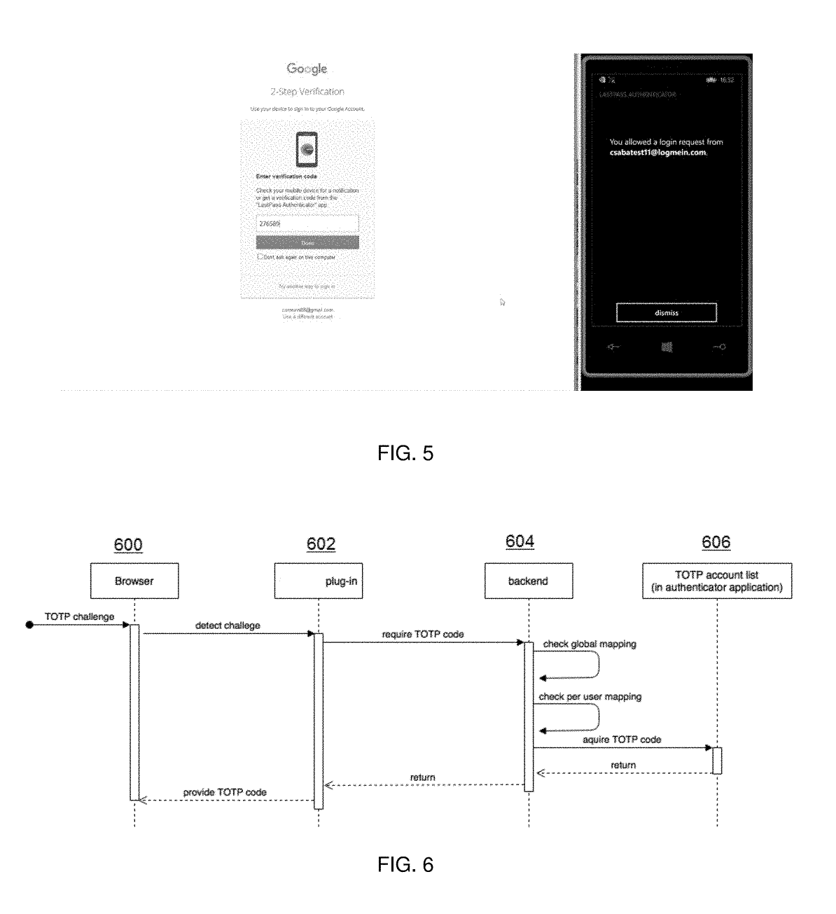

Once the user selects allow (thus accepting the push notification), FIG. 5 depicts that browser plug-in operation by which the TOTP code is automatically populated in the HTML fill-in form and the form submitted to complete the programmatic login.

The solution enables push notification-based TOTP authentication even for cloud applications that do not otherwise support two factor authentication.

### Tracking and Managing Multiple TOTP Accounts

With the above as background, the following describes this subject matter of this disclosure.

Existing authenticator applications typically represent a TOTP account with an issuer and a username. When a TOTP code is required for a given website, a human user can find the correct TOTP account in the authenticator application for a site relatively easily, e.g., by examining the issuer information. Locating TOTP account information programmatically, however, presents significant challenges. In particular, creating a simple mapping is not feasible due to the very large number of websites using TOTP technology. Thus, there remains a need to provide for a mechanism to provide an automated way to retrieve a TOTP code for a website.

The following describes a method to implement TOTP account matching. This aspect of the disclosure provides for a solution to handle multiple TOTP accounts while providing a way to find a particular account belonging to a given website. The technique enables a browser plugin to manage two factor authentication by enabling the plugin to keep track of multiple TOTP accounts while also selecting the one that should be used for a given website. Existing TOTP solutions simply rely on user interaction to be able to match a website (typically represented by a URL) to a TOTP account (represented by descriptive issuer and username values).

This aspect of the disclosure is now described. As described above, it is assumed that a system that incorporates this aspect comprises the authenticator application, the browser plugin, and a backend infrastructure, such as already described. Generally, the authenticator application is used to set up third party sites and to keep TOTP secrets. The browser plugin detects login on a specific site and sends the website URL to the backend, provides the user an account list, and sends mappings to the backend. The backend maintains TOTP account metadata and mappings, and performs URL-to-TOTP account matching, all as will be described.

The approach herein enables a website requiring the TOTP code to automatically acquire it from the authenticator application executing on the mobile device.

Referring back to FIG. 6, which depicts the basic operation, the entities include browser 600, a browser plug-in 602, a backend 604, and an authenticator app that includes the TOTP account list 606. As depicted, the TOTP account list 606 is stored in the authenticator app. The browser plug-in 602 may be a component of a password manager, such as LastPass™, although this is not a limitation.

The basic operation is as follows. The browser 600 receives the TOTP challenge, which is detected by the plug-in 602. The plug-in provides an indication to the backend 604 that a TOTP code is required. The backend 604 first checks for its global mappings to look for a match. If there is no global mapping, the backend then checks the per-user mappings. If there is no per-user mapping, the backend issues a request to the authenticator app 606 to acquire the TOTP code. The app returns the TOTP code to the backend, which then returns it to the plug-in, which then provides it to the browser.

In this embodiment, and as noted above, preferably the TOTP secrets preferably are maintained only on the authenticator app. TOTP metadata (e.g., issuer, account name, and an identifier) is synchronized to the backend. The issuer and account name metadata needs to be maintained at the authentication app in its original form so that it can be used for matching purposes; this is true even if the app allows for modification of this information. The backend includes a database (or multiple databases or, more generally, data structures) in which various mappings are maintained. These include a global URL-to-issuer mapping for well-known websites is maintained. As a further aspect of this disclosure, the backend database also includes “per user” URL-to-issuer mappings that are not included in the global mapping database and that are created according to the technique below.

As FIG. 6, depicts, when the TOTP code is required for a given website, the following operations are then carried out. First, the website URL is sent to the backend where the TOTP metadata is hosted. The global mapping is checked to determine whether there is a TOTP account on the authenticator app. If no match is found, then the per user mapping is checked. If any match is found, the TOTP code is retrieved from the authenticator app. If no match is found, the user is provided the option to associate one of his or her TOTP accounts from the authenticator application to the website. One of several options may then be used for this purpose.

In a first option, the user can select an account for a given website from the list of his or her available TOTP accounts (in the browser) in the same way as currently used for usernames. When an account is chosen, the TOTP code for the given account is requested from the mobile device. If login is completed with the user-selected account, the mapping is then added to the per-user mapping on the backend.

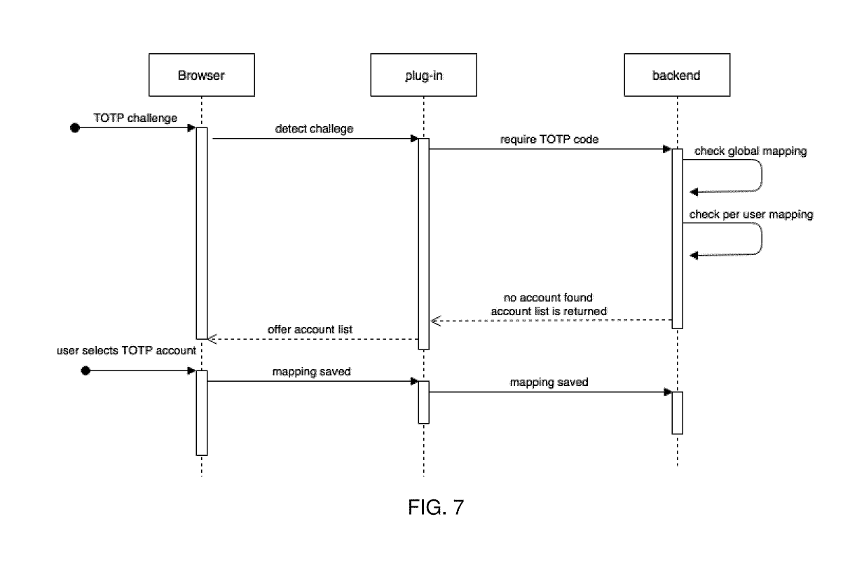

The first option is depicted in detail in FIG. 7. The browser receives the TOTP challenge; the plug-in detects this challenge and issues a request for the TOTP code from the backend. The backend checks the global mappings and then the per-user mappings, as described above, but no account is found. The account list is then returned to the plug-in, which then offers the account list to the browser. As depicted at the bottom, the user selects the TOTP account manually, and (if login is successful) the browser forwards the mapping to the plug-in, which then saves the mapping in the per-user mapping table in the backend to complete the processing in the first option. In a variant of this scenario, when no account is found the backend may provide the plug-in just the metadata.

In a second option, the user manually enters the TOTP code obtained from the authenticator app in his or her browser. If login is completed, an account with the same TOTP code is looked up from the user's available TOTP accounts, and the user can confirm (in the browser) to create a mapping between the website and the TOTP account in the backend.

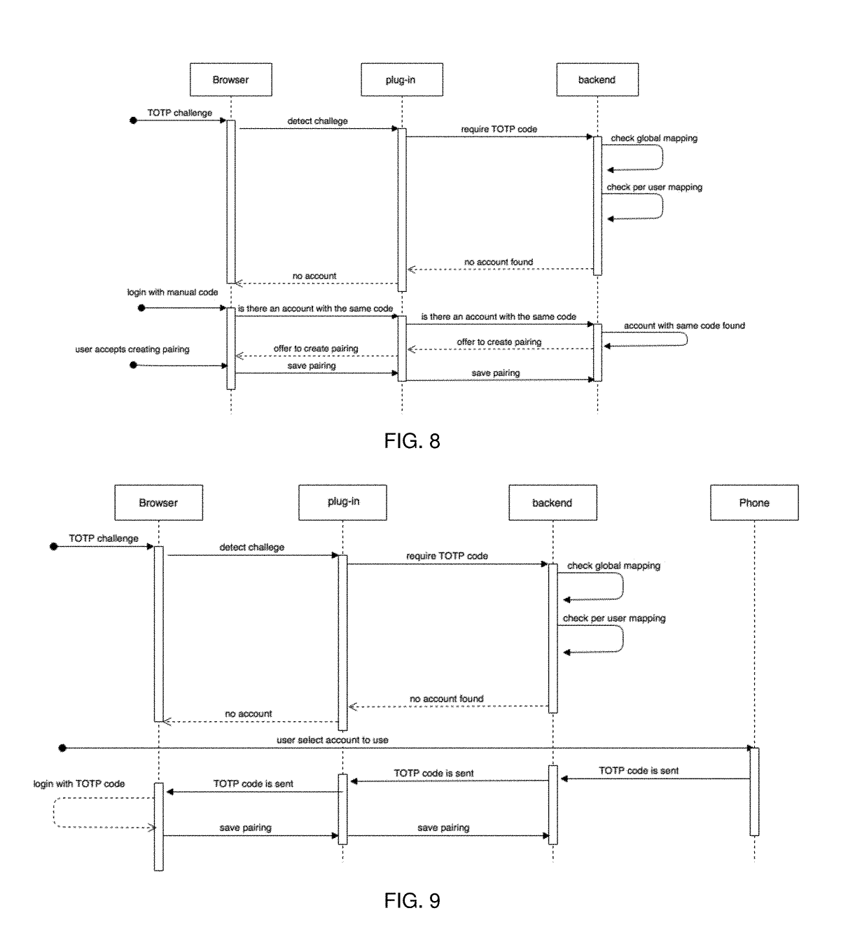

The second option is depicted in detail in FIG. 8. Once again, the browser receives the TOTP challenge; the plug-in detects this challenge and issues a request for the TOTP code from the backend. The backend checks the global mappings and then the per-user mappings, as described above, but again no account is found. An indication to this effect is passed from the backend to the plug-in, and then to the browser. As depicted at the bottom, the user then logins with the manual code. The browser then checks with the plug-in to see if there is an account with the same code. The plug-in passes this message to the backend. There is a low possibility of this occurring. Thus, the backend returns a response offering to create a pairing. The offer is forwarded from the plug-in to the browser. After the user accepts, the pairing is creating and saved from the browser to the plug-in to the backend, where it is stored.

In a third option, the user selects the TOTP account to use from the authenticator app. The TOTP code is transferred from the authentication app to the browser plugin, which then automatically inserts the TOTP code and performs the login. If the login is completed, a mapping is created on the backend.

The third option is depicted in detail in FIG. 9. In this scenario, the browser receives the TOTP challenge; the plug-in detects this challenge and issues a request for the TOTP code from the backend. The backend checks the global mappings and then the per-user mappings, as described above, but no account is found. The account list is then returned to the plug-in, which then offers the account list to the browser. As depicted at the bottom, the user selects the TOTP account manually (from the authenticator app on the mobile device). The selected TOTP code is sent from the mobile device to the backend, which then forwards it to the plug-in, which then forwards it to the browser. Login with the TOTP code is then carried out, with the pairing then saved from the browser to the plug-in to the backend. This completes the process for the third option.

### Enabling Technologies

A mobile device comprises a CPU (central processing unit), computer memory, such as RAM, and a drive. The device software includes an operating system (e.g., Apple iOS, Google® Android™, or the like), and generic support applications and utilities. The device may also include a graphics processing unit (GPU). It also includes a touch-sensing device or interface configured to receive input from a user's touch and to send this information to processor. The touch-sensing device typically is a touch screen. The touch-sensing device or interface recognizes touches, as well as the position, motion and magnitude of touches on a touch sensitive surface (gestures). The device typically also comprises a high-resolution camera for capturing images (e.g., QR codes), an accelerometer, a gyroscope, and the like.

The push notification may be provided to the mobile device in any convenient manner, e.g., Apple Push Notification (APN) Service (APN), Google push notification services (for iOS or Android), or the like.

The authenticator app may be the LastPass® mobile password manager authenticator app (or equivalent), which is augmented to include the capability to call the cloud service to store the TOTP shared secret per user per site, as described above.

The TOTP secrets per site per user are securely stored in the cloud service using a secure repository.

The cloud service may be associated with a remote access technology platform and service, such as LogMeIn.

In one embodiment, a cloud service provider provides the cloud service, the mobile device authenticator app, and the browser plug-in.

In another embodiment, the cloud service provider provides the cloud service and the mobile device authenticator app.

The cloud service is a technology platform that may comprise co-located hardware and software resources, or resources that are physically, logically, virtually and/or geographically distinct. Communication networks used to communicate to and from the platform services may be packet-based, non-packet based, and secure or non-secure, or some combination thereof.

More generally, the cloud service comprises a set of one or more computing-related entities (systems, machines, processes, programs, libraries, functions, or the like) that together facilitate or provide the described functionality described above. In a typical implementation, a representative machine on which the software executes comprises commodity hardware, an operating system, an application runtime environment, and a set of applications or processes and associated data, that provide the functionality of a given system or subsystem. As described, the functionality may be implemented in a standalone machine, or across a distributed set of machines.

The computing entity on which the browser and its associated browser plug-in run may be any network-accessible computing entity that is other than the mobile device that runs the authenticator app itself. Representative entities includes laptops, desktops, workstations, other mobile devices or machines associated with such other mobile devices, and the like.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

While the disclosed subject matter has been described in the context of a method or process, the subject disclosure also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including an optical disk, a CD-ROM, and a magnetic-optical disk, a read-only memory (ROM), a random access memory (RAM), a magnetic or optical card, or any type of media suitable for storing electronic instructions, and each coupled to a computer system bus.

While given components of the system have been described separately, one of ordinary skill will appreciate that some of the functions may be combined or shared in given instructions, program sequences, code portions, and the like.

The described commercial products, systems and services are provided for illustrative purposes only and are not intended to limit the scope of this disclosure.

The described technique may include other variants. In yet another alternative, the TOTP secret need not be maintained in the cloud service, but rather is maintained at the host (e.g., in a secure data store). After the push notification, the locally-stored secret is then used to generate the TOTP code, which is then populated (once again by the plug-in) into the fill-in form. In this example variant, the various operations involving the cloud service are not required.

In another variant, the dynamic generation and injection of the TOTP code (derived from the shared secret) occurs in a single device solution, in which case even the push notification may not be required.

The techniques herein provide for improvements to technology or technical field, namely, cloud-based access control, as well as improvements to various technologies such as secure authentication, and the like, all as described.

Having described our invention, what we now claim is as follows:

1. A method to manage TOTP accounts, comprising:
establishing and maintaining a website-to-TOTP issuer data structure for a first set of websites;
establishing and maintaining a website-to-TOTP issuer data structure for a second set of websites, the second set of websites being distinct from the first set of web sites and being associated with a particular user;
responsive to receipt of a request for a TOTP code, the request being received during an attempt to login to a given website, checking the website-to-TOTP issuer data structure(s) for a match;
responsive to a determination that a match does not exist, issuing a request to obtain a TOTP account; and
responsive to receipt of a response to the request to obtain the TOTP account, updating the website-to-TOTP issuer data structure for the second set of websites.

2. The method as described in claim 1 wherein the website-to-TOTP issuer data structure for the first set of websites is checked for the match first.

3. The method as described in claim 2 wherein the website-to-TOTP issuer data structure for the second set of websites is checked if no match is found for the first set of websites.

4. The method as described in claim 1 wherein the website-to-TOTP issuer data structure corresponds for the first set of websites represents a global mapping table for commonly-used websites.

5. The method as described in claim 1 wherein the receipt of the request for a TOTP code is received from a browser plug-in.

6. The method as described in claim 1 wherein the response to the request to obtain the TOTP code is obtained in association with a user selecting from a browser-displayed list an account for the given website from a list of available TOTP accounts.

7. The method as described in claim 1 wherein the response to the request to obtain the TOTP code is obtained in association with a user entering into a browser a TOTP code obtained from an authenticator app.

8. The method as described in claim 1 wherein the response to the request to obtain the TOTP code is obtained in associated with a user selecting a TOTP code to user from an authenticator app.

9. Apparatus to manage TOTP accounts in a backend infrastructure, comprising:
a processor;
computer memory;
a data store storing (a) common URL-to-TOTP issuer mappings; and (b) per-user URL-to-TOTP issuer mappings; and
program code held in the computer memory and executing by the processor to dynamically update the per-user URL-to-TOTP issuer mappings to enable automated and reliable locating of a correct TOTP code for a given website.
